(19) United States
(12) Patent Application Publication
(10) Pub. No.: US 2007/0097159 A1
(43) Pub. Date: May 3, 2007

(54) Methods for reducing die-to-die color inconsistances in a multi-die printing system

(76) Inventor: Behnam Bastani, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,864

(22) Filed: Oct. 28, 2005

(51) Int. Cl. B41J 29/38

(52) U.S. Cl. 347/5

(57) ABSTRACT

Methods are disclosed for reducing die-to-die color inconsistencies in a multi-die printing system. A die is linearized and becomes the reference die; density measurements are made for each pair of adjacent die, and the density comparisons are utilized to map the linearization data to each of the remaining die. The methods may utilize an optical sensor having good resolution as a densitometer, but which may lack stability.

### FIELD OF INVENTION

This invention relates generally methods of calibrating the performance of printing systems, and more specifically to methods of reducing die-to-die color inconsistencies in a multi-die printing system.

### BACKGROUND

Inkjet printing systems are also are well known in the art. Small droplets of liquid ink, propelled by thermal heating, piezoelectric actuators, or some other mechanism, are deposited by a printhead on a print media, such as paper.

In scanning-carriage inkjet printing systems, inkjet printheads are typically mounted on a carriage that is moved back and forth across the print media. As the printheads are moved across the print media, the printheads are activated to deposit or eject ink droplets onto the print media to form text and images. The print media is generally held substantially stationary while the printheads complete a “print swath”, typically an inch or less in height; the print media is then advanced between print swaths. The need to complete numerous carriage passes back and forth across a page has meant that inkjet printers have typically been significantly slower than some other forms of printers, such as laser printers, which can essentially produce a page-wide image.

The ink ejection mechanisms of inkjet printheads are typically manufactured in a manner similar to the manufacture of semiconductor integrated circuits. The print swath for a printhead is thus typically limited by the difficulty in producing very large semiconductor chips or “die”. Consequently, to produce printheads with wider print swaths, other approaches are used, such as configuring multiple printhead dies in a printhead module, such as a “page wide array”. Print swaths spanning an entire page width, or a substantial portion of a page width, can allow inkjet printers to compete with laser printers in print speed.

One type of inkjet printing system utilizes multiple printhead modules that each print a substantial portion of a page width. The printhead modules in this type of system may include multiple printhead die linearly spaced across the print swath, such that each die prints a portion of the swath, typically one inch or less. Since the printhead die invariably differ slightly in their characteristics, such as drop weight, if corrections are not made for the slight differences between the die visible print quality defects may be introduced. For example, different die may print at slightly different densities. Since the print swaths of the individual die are immediately adjacent, such defects are readily discernible, particularly when attempting to reproduce high quality graphics and images. Banding in an area representing sky in a photograph, for example, is easily observed.

There is thus a need for methods of reducing die-to-die color inconsistances in a multi-die printing system.

### SUMMARY

Exemplary embodiments of the invention include methods of reducing die-to-die color inconsistencies in a multi-die printing system. A die is linearized and becomes the reference die; density measurements are made for each pair of adjacent die, and the density comparisons are utilized to map the linearization data to each of the remaining die. The methods may utilize an optical sensor having good resolution as a densitometer, but which may lack stability.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates an exemplary printing system in which exemplary embodiments of the invention may be utilized;

FIG. 2 illustrates the paper path and printhead mechanisms of an exemplary inkjet printing system in which embodiments of the invention may be utilized;

FIG. 3 is a block diagram further illustrating a system in which embodiments of the invention may be employed;

FIG. 4 is a bottom perspective view of an exemplary compact optical sensor which may be used in embodiments of the invention;

FIG. 5 is a side elevational sectional view of the exemplary compact optical sensor of FIG. 4, shown monitoring a portion of a sheet of print media, such as paper;

FIG. 6 is an exploded view of the exemplary compact optical sensor of FIG. 4;

FIG. 7 is a graph showing the relative specular reflectances and specular absorbances versus illumination wave length for cyan, yellow, magenta and black inks, and for blue, green, soft-orange and red illuminating Light emitting diodes (LEDs) used by the exemplary optical sensor of FIG. 4 when monitoring images printed on white media, such as plain paper;

FIG. 8 illustrates in a simplified form how multiple printhead die are arrayed within an exemplary printhead assembly;

FIG. 9 illustrates how ramps of varying print density may be deposited on a print media by multiple printhead die;

FIG. 10 is a plot illustrating an exemplary linearization table for a printhead die; and

FIG. 11 is a flow chart further illustrating an embodiment of the present invention.

### DESCRIPTION OF EMBODIMENTS OF THE INVENTION

Embodiments of the invention are described with respect to an exemplary inkjet printing system; however, the invention is not limited to the exemplary system, nor to the field of inkjet printing, but may be utilized as well in other systems.

In the following specification, for purposes of explanation, specific details are set forth in order to provide an understanding of the present invention. It will be apparent to one skilled in the art, however, that the present invention may be practiced without these specific details. Reference in the specification to “one embodiment” or “an exemplary embodiment” means that a particular feature, structure, or characteristic described in connection with the embodiment is included in at least one embodiment. The appearance of the phrase “in one embodiment” in various places in the specification do not necessarily refer to the same embodiment.

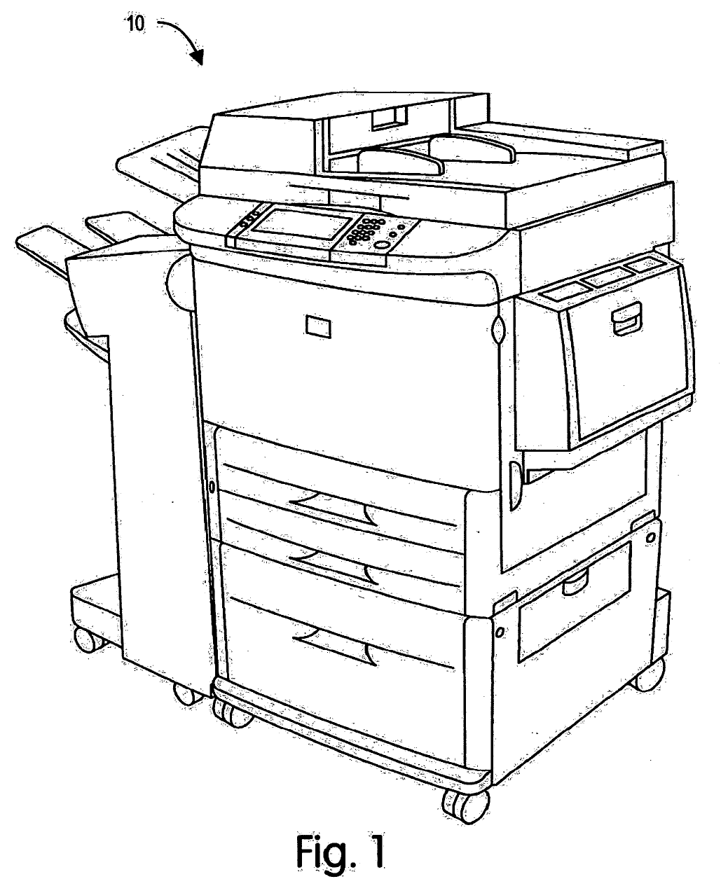

FIG. 1 illustrates an exemplary inkjet printing system 10 in which embodiments of the invention may be utilized. Intended for moderately high volume printing, the system may also include multiple other functions and may, for example, be connected to an office network to provide printing, scanning, and faxing capabilities to a workgroup. Methods of the invention may also be applied to other printing systems, such as those used for photo printing.

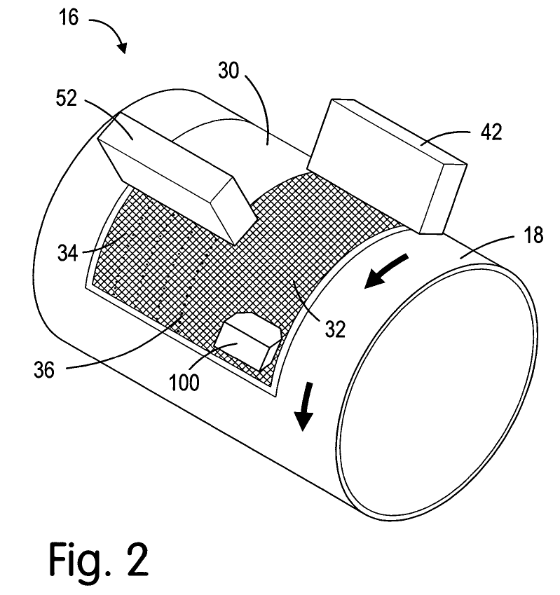

FIG. 2 illustrates the basic media path and printhead mechanisms 16 of an exemplary inkjet printing system 10 in which embodiments of the invention may be utilized. As shown in FIG. 2, print media 30, such as a sheet of paper, is held to a rotating drum 18 by air suction. The print media 30 is rotated past printhead assemblies on print carriages 42, 52 that remain substantially stationary during a printing pass (although the carriages may be repositioned between passes, such as to allow printing of wider media using multiple passes). Multiple carriages with printhead assemblies may be utilized to span the page width as illustrated; one printhead assembly on a first carriage 42 may print a first portion 32 of the page width, and a second printhead assembly on a second carriage 52 may print a second portion 34 of the page width. Where the two portions of the printed page meet is a joint 36, which ideally is not readily perceptible on the completed page.

The multiple printhead assemblies 42, 44 may in turn each comprise multiple separate printhead die, with each die positioned to print a portion of the total print swath, as further explained below. Print swath 34 is shown in FIG. 2 as comprising four smaller swaths, such as would be produced by four separate die on printhead assembly 52. The use of separate die may result in inconsistent color or tone across the complete print swath, a problem addressed by embodiments of the present invention, as also discussed below.

For multi-pass printing, the print media 30 may be held to the drum 18 by suction for more than one complete revolution of the drum, with printheads on the carriage assemblies 42, 44 depositing ink during each pass of the print media. The printer may include drying mechanisms (not shown) to accelerate the drying of the printed media, which may, for example, be placed near the bottom of the drum 18 such that the printed media may be at least partially dried between printing passes. The carriage assemblies 42, 52 permit the printheads to be moved side-to-side to different locations on the drum or off the drum entirely for servicing, or to reposition the printheads for different paper configurations.

Also positioned adjacent to print drum 18 is a compact optical sensor system 100, described in detail below. In a similar manner to the printhead assemblies 42, 52, the compact optical sensor system 100 is also configured to be repositioned at different locations across the printhead drum, such that, for example, the optical characteristics of printed samples from different printhead die may be sampled. In an actual printing system, the compact optical sensor 100 may be located on the same carriage mechanism as one of the printhead assemblies 42, 52 to reduce system cost and complexity. To allow for drying of the media and for making multiple measurements, the drum may make one or more rotations before or between sensor readings.

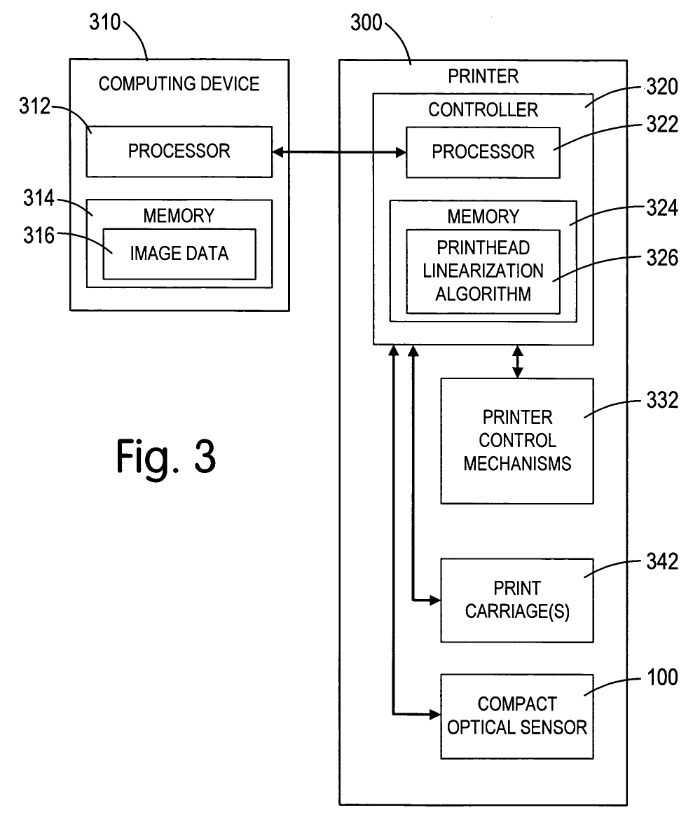

FIG. 3 is a schematic view of the exemplary inkjet printing system of FIGS. 1 and 2. Computing device 310 may be a computer directly connected to the printing system 300, or there may be multiple computers accessing the printing system over a network, such as a Local Area Network (LAN). Alternatively, some processing capabilities may be incorporated into the printer itself, such as in a photo printer. Computing device 310 typically includes a processor 312 having access to memory 314 including image data 316. The computing device 310 typically formats the image data in a form which may be utilized by printing system 300.

Printing system 300 typically includes a controller 320 which includes a processor 322 having access to memory 324. The memory may include the exemplary printhead calibration algorithms 326 of the present invention, together with other programs, parameters, and print data.

The controller 320 typically generates print data for each carriage assembly 342 of the printer, and also controls other printer mechanisms 332, such as, for example, controlling the drum rotation, paper feeding mechanism, and media dryers (not shown). The controller also interfaces with the compact optical sensor 100, controls it's positioning on the print drum and the optical stimulus generated by the sensor, and acquires measurements from the sensor, as discussed below.

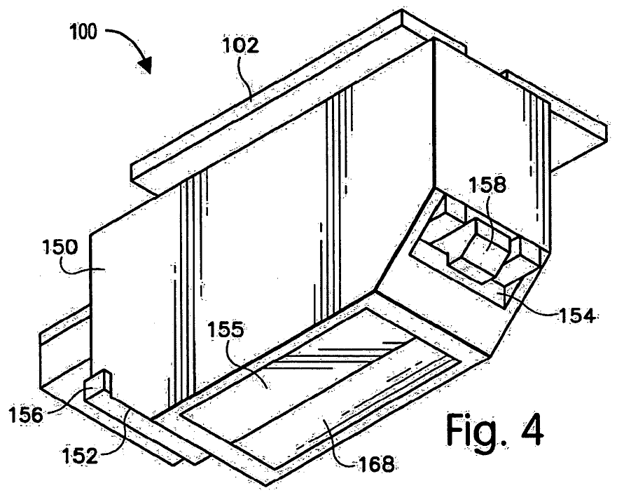

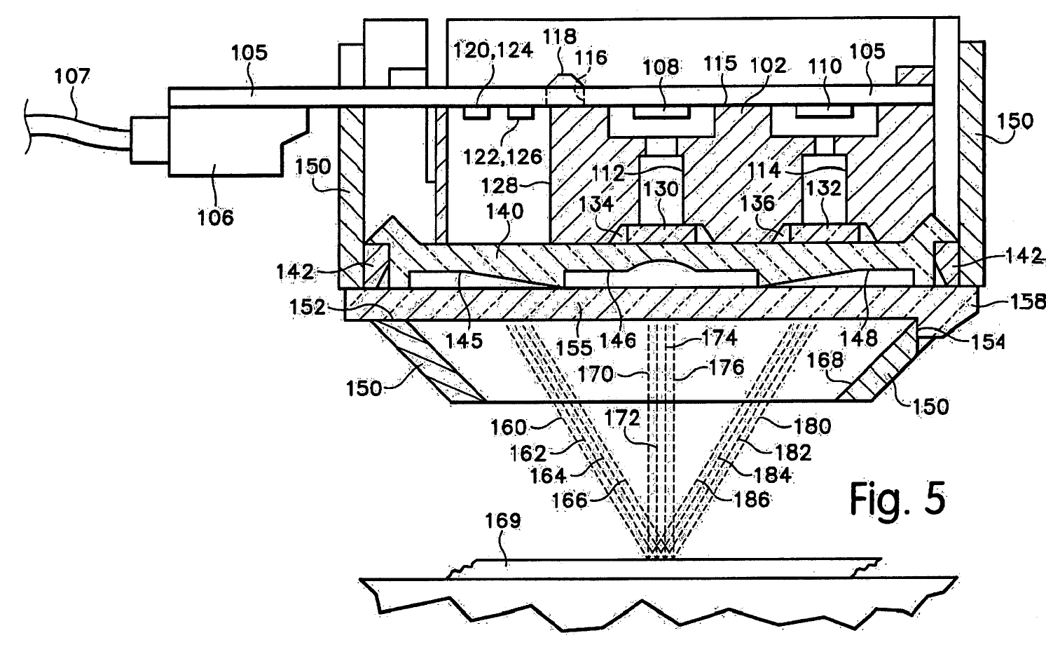

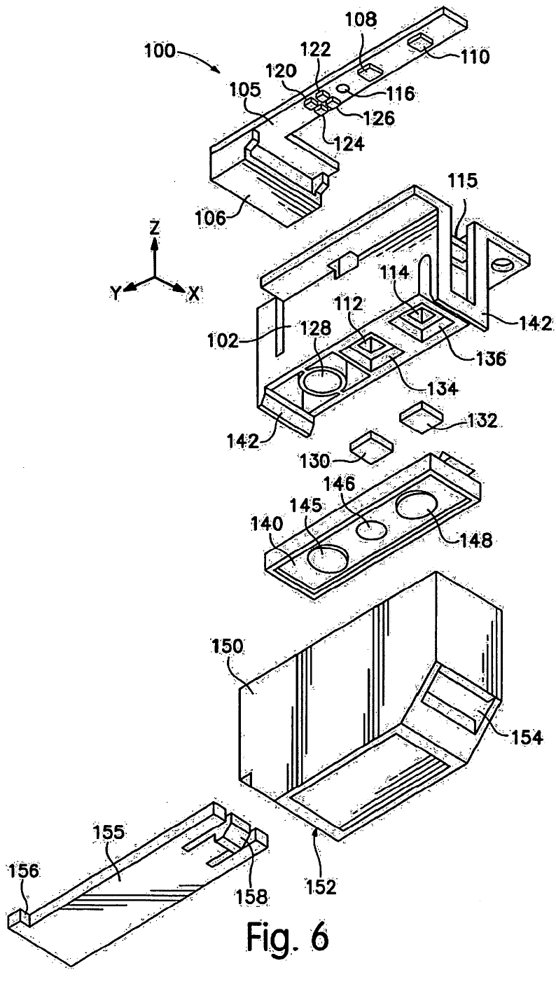

Shown in FIG. 4, and in greater detail in FIGS. 5 through 7, is an exemplary compact optical sensor system 100. The optical sensor 100 includes a housing or frame 102. The sensor 100 also includes a printed circuit assembly (“PCA”) 105 (see FIGS. 5 and 6), having a connector receptacle 106 that communicates with controller 320 via, for instance, conventional flexible cables (107). The PCA 105 includes two light-to-voltage converters, or photodiodes 108, 110 for receiving diffuse and specular reflected light, respectively. Preferably, each of the photodiode light-to-voltage converters 108, 110 are identical in construction to provide ease of manufacturing and a more economical, compact optical sensor 100. The output voltage is an analog signal which is passed through an amplifier (not shown). This amplified signal is then passed to an analog-to-digital (“A/D”) converter which may be a portion of the printed circuit assembly 105, or a portion of the controller 320.

The PCA board 105 is constructed such that the specular and diffuse photodiodes 108, 110 receive light through incoming light passages 112, 114 defined by the housing 102. To align the photodiodes 108, 110 with the light passages 124, 114, the housing 102 includes a support surface 115, which preferably has a lip, shown to the right of photodiode 110 in FIG. 6, under which the PCA board 105 is received. In the illustrated exemplary embodiment, the PCA board 105 defines an alignment hole 116 therethrough, which when assembled is received upon an alignment post 118 extending upwardly from the housing support surface 115, as shown in FIG. 6.

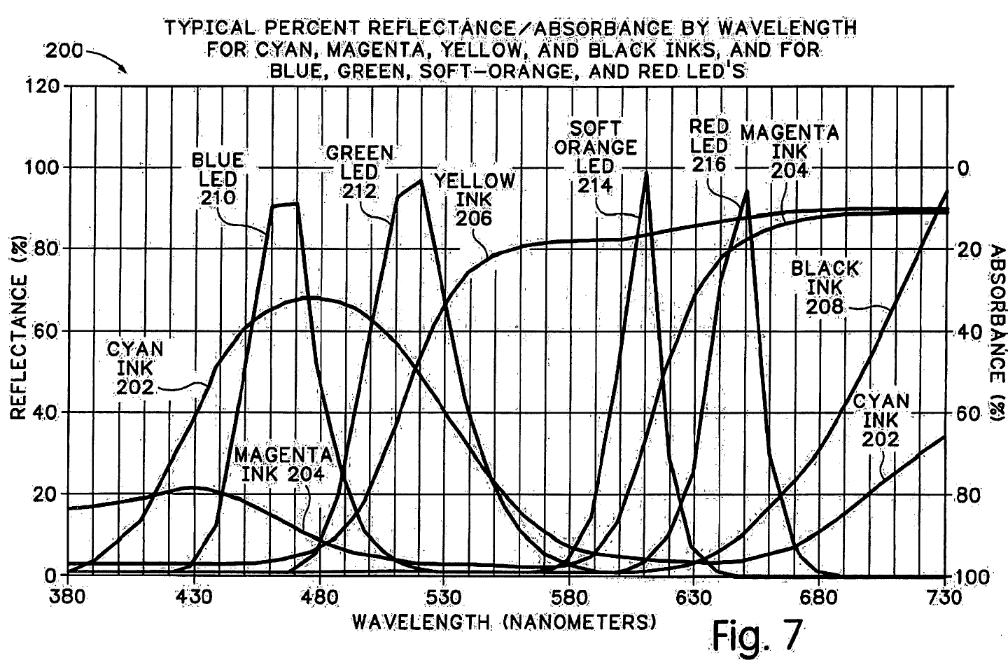

The PCA board 105 of the exemplary compact optical sensor system includes four light emitting diodes (LEDs) 120, 122,124 and 126 which, in the illustrated embodiment are the colors, blue, green, red and soft-orange, respectively. The construction of the printed circuit assembly 105 advantageously uses a chip-on-board (“COB”) process where the bare silicon die for each component is wire bonded directly to the printed circuit board assembly. Thus, in the illustrated embodiment, the light emitting diodes (LEDs) 120-126 may be closely grouped together, in a space smaller than that occupied by a single-packaged LED. Note that the LEDs 120-126 and photodiodes 108, 110 have been drawn in FIG. 7 to be about twice their normal size to better illustrate the concepts introduced herein. By clustering the light emitting diodes 120-126 so closely, a single outgoing optical light path 128 defined by the housing 102 may accommodate light generated by all of these LEDs.

The illustrated exemplary embodiment may also include two filter elements, one a diffuse filter element 130, and the other a specular filter element 132, preferably of colors selected to block long, infrared wavelengths, although in some implementations, other filters may be used to either filter or pass through more specific wavelength bands. In the illustrated embodiment, the filter elements 130, 132 are typically infrared wavelength blocking filters, such as those designed to block infrared wavelengths between 700 and 1000 nm (nanometers). Each of the filter elements 130, 132 are received within a recessed shelf portion 134, 136 defined by the housing 102. The filter elements 130, 132 serve to limit the incoming light to the diffuse and specular photodiodes 108, 110 to light within the regions of the visible spectrum. In some embodiments, an upper portion of the incoming light passages 112, 114 is molded with a square diffuse stop, and a rectangular specular stop, with the longitudinal axis of the specular stop running perpendicular to the longitudinal axis of the housing 102, that is, parallel with the X-axis. Again, the term “stop” refers to a window through which incoming light passes before it is received by in this case, the specular photodiode 110.

The exemplary compact optical sensor 100 also includes a lens assembly 140, which is received by a pair of lower extremities 142 of the housing 102. In this manner, the filter elements 130,132 are held in place within recesses 134, 136 by the lens assembly 140. The lens assembly 140 includes an outgoing LED lens 145, and two incoming lenses, here, a diffuse lens 146 and a specular lens 148. The lens elements 145, 146 and 148 are preferably selected to better focus and direct the light beams to follow the paths shown in FIG. 6, and as discussed further below after the remaining components of the optical sensor 100 have been introduced.

Preferably the exemplary sensor 100 includes an ambient light shield member 150. The ambient light shield 150 slides over the lens assembly 140 and is attached to the housing 102, for instance using various snap fitments, bonding elements, such as adhesives, fasteners or the like (not shown). The ambient light shield 150 has a pair of opposing slots 152 and 154 which are located to receive and secure a clear aerosol shield member 155. The aerosol shield 155 in the illustrated embodiment is inserted through slot 152 then through slot 154, with the forward insertion being limited by a stop 156 encountering a portion of the body of the ambient light shield 150 (see FIG. 5). A snap fitment member 158 flexes upwardly during insertion of the aerosol shield 155, then latches down over a lower portion of the slot 154 (see FIG. 5) to hold the aerosol shield 155 in place within the ambient light shield 150. Preferably, the aerosol shield 155 has an anti-reflection coating or property which allows light beams to pass therethrough without undue interference from the aerosol shield 155.

Turning to the operation of the exemplary compact optical sensor 100, as shown in FIG. 5, we see the Light emitting diodes (LEDs) 120, 122, 124, and 126 emitting light beams through the outgoing passageway 128, through the outgoing lens 145, and emerging as light beams 160, 162, 164, and 166, respectively exiting through a light entrance/exit chamber portion 168 of the ambient light shield 150. The emerging light beams 160-166 impact an upper exposed print surface of a sheet of print media 169, such as, for example, a sheet of paper. Light beams 160, 162, 164, and 166 are reflected directly off the media 169 as upwardly directed diffuse light beams 170, 172, 174, and 176, respectively. The term “diffuse” refers to light which is scattered (at any angle) when reflected from a surface. The portion of the diffuse light which is used in the illustrated embodiment are the perpendicular beams reflected off of the media 169, as shown for the diffuse light beams 170-176 in FIG. 5. The incoming diffuse light beams 170-176 pass through lens 146, through filter 130, and through the incoming light chamber 112 and through a rectangular stop or window 178 where they are received by the diffuse photodiode 108. The photodiode 108 is a light-to-voltage converter, as mentioned above, which interprets these incoming diffuse light beams 170-176 and produces a voltage signal proportionate to the intensity of these incoming light beams. This voltage signal is sent via receptical 106 and cable 107, and ultimately to controller 320, where this information may then be used by the controller to adjust various printing parameters.

Besides forming diffuse light beams 170-176, the incoming light beams 160, 162, 164 and 166 reflect off of the media 169 to form incoming specular light beams 180, 182, 184 and 186, respectively. The specular light beams 180-186 are reflected off of the media 169 at the same angle as the incoming light beams 160-166 impacted the media 169, (i.e., the angle of incidence equals angle of reflection). In the illustrated embodiment, preferably the irradiance from each illuminating LED 120-126 strikes the print surface plane of the sheet of media 169 at an angle of about 45-65°, or more preferably at an angle of 45°, referenced from the print surface of the media 169.

The specular reflectance light beams 180-186 pass through the light chamber 168 of the ambient light shield 150, through the aerosol shield 155, through the incoming specular lens 148, through the specular filter element 132, through the incoming light passageway 114, then through a specular stop window 187, after which they are received by the specular photodiode 110. The photodiode 110, which is a light-to-voltage converter, interprets the incoming light beams 180-186 and sends a signal to the controller 320.

The use of four different colors of light emitting diodes 120-126 permits the exemplary compact optical sensor 100 to perform media type sensing, color calibration (specifically, color, hue and intensity compensation), automatic pen alignment and swath height error/linefeed calibration. In the illustrated embodiment, the diffuse reflectance beams 170-176 detect the presence of the primary inks used in inkjet printers, such as, cyan, light cyan, magenta, light magenta, yellow and black. The specular light beams 180-186 are used to determine the reflective and other surface properties of the media 169, from which the type of media 169 may be determined, and the print routines then adjusted to match the type of media. Indeed, use of the four different colored Light emitting diodes (LEDs) 120-126 allows the compact optical sensor 100 to collect data which the controller 320 then may map to a three-dimensional color space which correlates to human perception of color. Moreover, while four light emitting diodes 120-126 are illustrated, it is apparent that other implementations may cluster additional LEDs above the outgoing light chamber 128, or another cluster of LEDs may be provided in the region of the specular photodiode 110 on the printed circuit assembly 105, foregoing media type determination in favor of additional color sensing capability.

A further advantage made use of in the optical sensor 100 is the arrangement of the colors of the LEDs 120-126. In the illustrated embodiment, it is preferred to have LED 120 to be a blue color, LED 122 to be a green color, LED 124 to be a red color and LED 126 to be a soft-orange color, with LEDs 120 and 124 being furthest away from the diffuse photodiode 108, and LEDs 122 and 126 being closer to the diffuse photodiode 108. In the illustrated embodiment, using the particular types of LEDs 120-126 and lens 145 selected, this physical arrangement yields an economical and high performance sensor 100.

FIG. 7 is a graph 200 illustrating the manner in which the colors for the LEDs 120-126 were selected, here based upon the colors of ink and their specular responses used in the printer 20. In FIG. 7, the various wavelengths and percentage of reflectance and percentage of absorbance are shown for the four primary colors ejected by a typical printing unit 10 and for the four LEDs 120-126 of sensor 100. For the inks, graph 200 shows a cyan colored ink trace 202, a magenta colored ink trace 204, a yellow colored ink trace 206 and a black color ink trace 208. In the illustrated embodiment, graph 200 shows a blue LED ink trace 210 which is emitted by LED 120, a green LED trace 212 which is emitted by LED 122, a red LED ink trace 216 which is emitted by LED 124, and a soft-orange LED ink trace 214 which is emitted by LED 126.

The selection of the four LED colors was arrived at by an intensive study evaluating reflections from the interaction of a variety of different illuminating colors with each of the test colors. These interactions were either found through laboratory measurements, or by graphical comparisons of the spectral responses of the inks versus the illumination data provided by the manufacturers of the variety of LEDs available. When measuring any particular color sample, each of the four LEDs 120-126 may be illuminated in sequence, with the resulting diffuse light beams 170-176 then being interpreted by the diffuse light-to-voltage converter 108 to find the percentage of reflectance and/or absorbance. By comparing the reflectance values received when illuminated by the different LEDs 120-126, the various shades may be distinguished by controller 320. For instance, turning to FIG. 7, the cyan ink curve 202 may be distinguished from the other ink curves because the blue LED generates maximum reflectance, the green LED a medium reflectance, and the soft orange and red LEDs generate minimal reflectances. For the magenta ink curve 204, the blue LED generates a small reflectance, the green LED generates a minimal reflectance, the orange LED generates a medium reflectance, while the red LED generates a high reflectance.

The sensor described with respect to FIGS. 4 through 7 may provide relatively high resolution densitomer readings, but may be somewhat inadequate as spectrometer, in that noise in the sensor readings, sensor drift over time, and the contribution of the print media to the sensor readings may affect the resulting measurements. The minor inaccuracies due to sensor drift are typically not of concern when using the sensor to calibrate a single printhead die, since the small inaccuracies would not be readily observable when viewed in isolation. The inaccuracies may become a factor in a multi-die printing system, however.

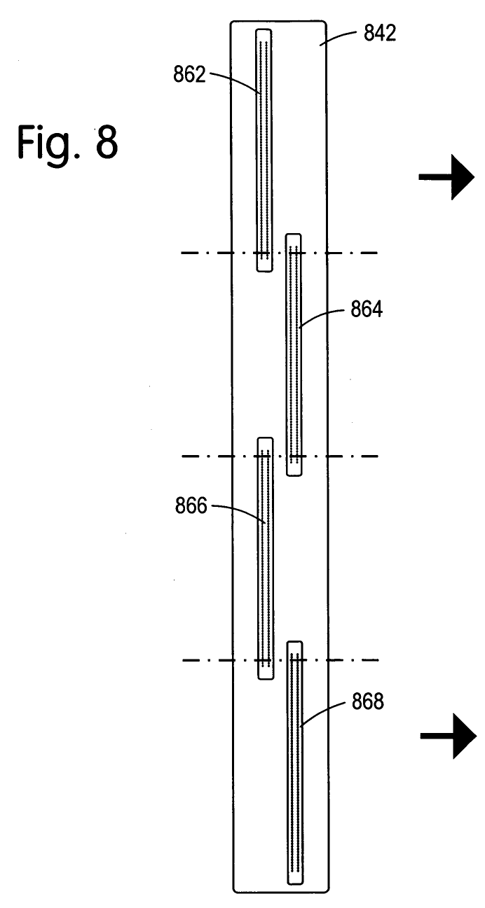

FIG. 8 illustrates in simplified form how multiple printhead die 862, 864, 866, 868 are arrayed within a printhead assembly 842. Each of the printhead die 862, 864, 866, 868 is shown having two linear arrays of print nozzles, such as might be used to print two different ink colors. A printhead assembly may include die for printing mutliple ink colors or printing fluids, such as, for example, cyan, magenta, yellow, black, and fixer. The individual die are arrange in a staggered pattern perpendicular to the direction of the media transport (indicated by the arrows). As indicated by the dashed lines, each printhead die overlaps the span of the adjacent dies by a small amount (i.e., there is a region near the ends of adjacent die where the rows of nozzles of the adjacent die overlap).

To produce the range of tonal values required for graphics and photographs, printhead die are typically calibrated, or “linearized”, such that the print densities of halftoned images substantially correspond to the densities of the continuous tone, or “contone” images, which are to be printed. Typically, measurements of the actual print density of the printhead die are made over the range of print densities, and a curve-fitting routine then “linearizes” the die (see e.g. Wu et al., U.S. Pat. No. 6,851,785, “Calibration Method and Apparatus Using Interpolation”). The linearization information may be stored in a non-volatile memory as a look-up-table (LUT) or as coefficients of an equation.

Independently linearizing each of the die in a multi-die system, however, may not adequately account for die-to-die variations. Assuming a linearized die has a density error equal to “α” then the difference between any two die is potentially 2α. If the two die are adjacent, a 2α density difference may be unacceptable.

Since all the die in an exemplary multi-die system have very similar physical characteristics, having been similarly manufactured, the shape of the linearization curves will also be similar, typically differing only by a constant adjustment, such a multiplication factor.

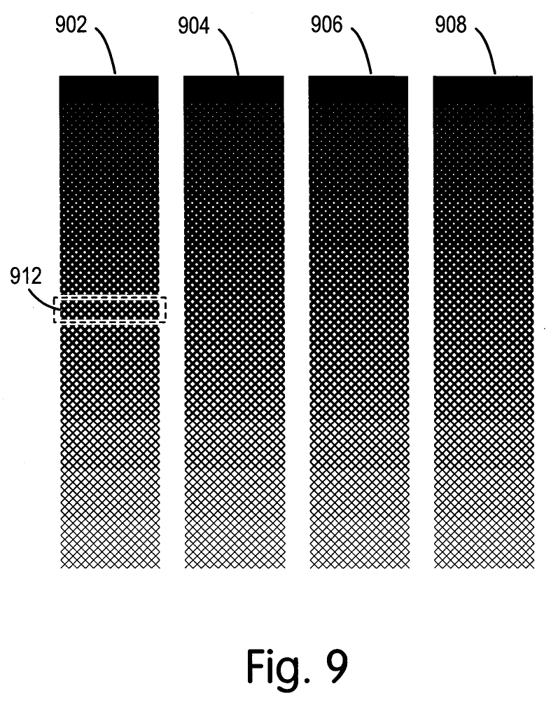

FIG. 9 illustrates how a “ramp” of varying print density may be deposited on a print media by each die of a multi-die printing system, such as the die 862, 864, 866, 868 of FIG. 8. FIG. 9 is intended to be illustrative only, and does not necessarily represent ramps printed by a actual system. FIG. 9 shows how density ramps 902, 904, 906, 908 may be printed in parallel for multiple printhead die. A ramp may, for example, include regions printed with sixteen discrete print densities equally spaced along the range of available “raw” print densities. After printing, the ramps may be repeatedly moved past the compact optical sensor 100, as the drum 18 of the exemplary printing system rotates the media past the sensor.

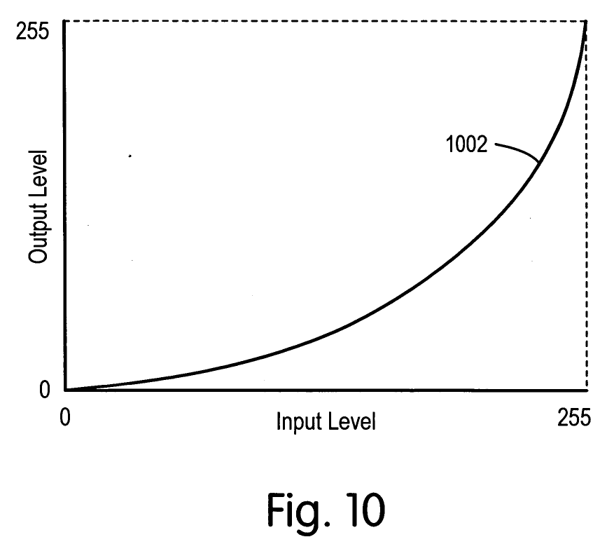

FIG. 10 is a plot depicting an exemplary linearization table for a printhead die. The plot shows input level on the horizontal axis and output level on the vertical axis. The response curve 1002 represents the calibration necessary to cause the printhead to print tones linearly in the printer color space. For example, the input level may be an 8-bit value from 0 to 255, which is converted to a linearized output level, also an 8-bit value from 0 to 255. The curve may be stored in non-volatile memory as a table of values or as coefficients in a mathematical equation.

In exemplary embodiments of the invention, rather than performing a separate linearization of each die, a single “reference” die is linearized, with the resulting curve then adjusted for each of the remaining die based on a determination of the relative print densities produced by each adjacent die. Thus, potential print density differences between any two adjacent die may be significantly reduced from those which would result from independently linearizing each die.

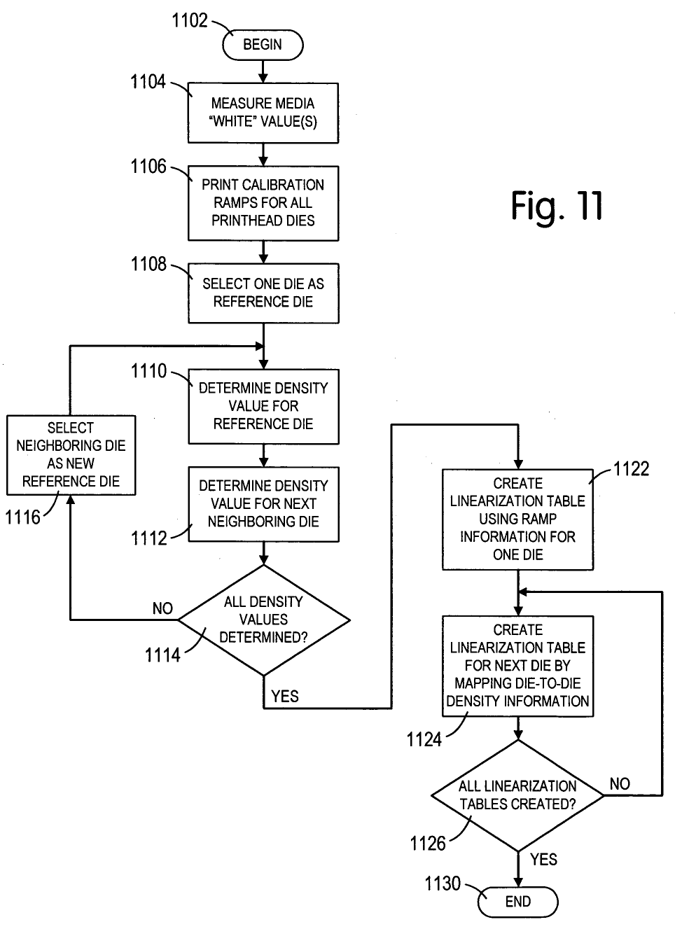

FIG. 11 is a flow diagram further illustrating an exemplary method of the invention. The method begins 1102 and the “white” value of the unprinted media is determined. That is, the unprinted media is scanned past the compact optical sensor, and a determination is made of a baseline “white” value for the color channel being linearized (i.e., in an exemplary system, cyan, magenta, yellow, or black). The determination of the white baseline may include one or more measurements utilizing one or more of the measurement capabilities of the optical sensor; a statistical process may be performed to arrive at a baseline white value (e.g., multiple readings may be averaged to reduce measurement noise). The white value will be used to correct subsequent readings of the optical sensor to reduce the effects of media characteristics on the linearization process.

Ramps are then printed 1106 using all dies of the printhead assembly, as shown in FIG. 9. In an exemplary system, this may be accomplished by continuing to rotate the print drum retaining the print media a revolution as the print head dies deposit ink. The ramps that are printed are created using unlinearized values, and thus exhibit any of the non-linearity that is present in the printheads. As discussed above, each ramp may represent multiple discrete regions (in an exemplary system, sixteen) of print densities spaced along the range of potential densities.

In an exemplary method, one printhead die is then selected as a reference die. Typically, this will be one of the end die of the printhead module, such as, for example, die 862 or die 868 in FIG. 8. A density value is then determined 1110 for the “reference” die. Determining a reference value may include one or more measurements utilizing one or more of the measurement capabilities of the optical sensor; a statistical process may be performed to arrive at a baseline density value (e.g., multiple readings may be averaged to reduce measurement noise). In the exemplary printing system illustrated in FIG. 2, for example, more than 100 readings may be taken as a print sample is scanned past the compact optical sensor. In exemplary embodiments, determining the density value may entail averaging readings obtained from the optical sensor within a region of the printed ramp, such as the area shown at 912 in FIG. 9.

A corresponding density value is then determined 1112 for the next neighboring die adjacent to the reference die. The density determinations for the reference die and next neighboring die may be determined in close time proximity, such that any effects on the determinations due to sensor drift are obviated or minimized. A “white” value for the media, determined before the density ramps were deposited, may be used to correct the density values. The two density measurements thus provide a basis for accurately mapping the differences between any two adjacent die.

If all the density values for the printhead module have not been determined 1114, the die that was the neighboring die in the previous step is now selected as the new “reference” die 1116, and density determinations are made for the new reference die and the next die in line. The process thus essentially steps along the printhead assembly, and generates density comparison data for each adjacent set of die.

When all density values have been determined, linearization tables may be created for each of the printhead die. In an exemplary embodiment, a linearization table is first created 1122 for one of the die, such as the original end die with which the process began. The ramp data previously printed may be utilized to create a linearization table for the die using methods known in the art (see e.g. Wu et al., U.S. Pat. No. 6,851,785, “Calibration Method and Apparatus Using Interpolation”). In the exemplary embodiment, the linearization table for the original end die then becomes a basis for the linearization tables of the remaining die, as the die-to-die density comparison information between adjacent dies is used to remap 1124 the linearization table to each of the remaining die. Mapping may include adjusting the values in a linearization look-up-table (LUT) or the coefficients of a linearization equation, such as by multiplying the values or coefficients by a factor based on the relative measured densities; or mapping may include other operations, such as adjusting an offset value. The mapping function may be empirically determined to provide best results in a particular printing system.

When all linearization tables have been created 1126, the exemplary method ends 1130. The exemplary method illustrated in FIG. 11 may be repeated for each color channel of the printhead module, such as, for example, cyan, magenta, yellow, and black. The exemplary method may also be extended to reduce color errors from printhead module to printhead module, such as, for example, between printhead modules 42 and 52 of FIG. 2, by continuing the process from the last printhead die of one module to the first printhead die of the next module.

An advantage of methods of the present invention is a significant decrease in the errors observed between adjacent print die. In comparison to an approach where each of the printhead die is separately linearized, embodiments of the invention have been determined to reduce the die-to-die error by roughly half.

The above is a detailed description of particular embodiments of the invention. It is recognized that departures from the disclosed embodiments may be within the scope of this invention and that obvious modifications will occur to a person skilled in the art. It is the intent of the applicant that the invention include alternative implementations known in the art that perform the same functions as those disclosed. This specification should not be construed to unduly narrow the full scope of protection to which the invention is entitled.

Embodiments of the invention include computer readable media containing program instructions for implementing the exemplary methods.

The corresponding structures, materials, acts, and equivalents of all means or step plus function elements in the claims below are intended to include any structure, material, or acts for performing the functions in combination with other claimed elements as specifically claimed.

What is claimed is:

1. A method for reducing die-to-die color inconsistencies in a multi-die printing system, comprising:
determining linearization information for one die;
determining relative print densities for the one die and at least one adjacent die; and
mapping the linearization information for the one die to the at least one adjacent die based on the determined relative print densities.

2. The method for reducing die-to-die color inconsistencies in a multi-die printing system of claim 1, wherein the printing system comprises more than two die, with each die forming an adjacent pair with at least one other die, and wherein the method further comprises:
for each adjacent pair of die, determining relative print densities of the pair of die; and
mapping the linearization information of the one die to each die based on the relative print densities of the pair of die.

3. The method for reducing die-to-die color inconsistencies in a multi-die printing system of claim 2, wherein the die are arranged sequentially along a printhead assembly, and wherein the one die is an end die on the printhead assembly.

4. The method for reducing die-to-die color inconsistencies in a multi-die printing system of claim 3, wherein the linearization information is mapped sequentially from the end die along the printhead assembly.

5. The method for reducing die-to-die color inconsistencies in a multi-die printing system of claim 1, wherein determining relative print densities comprises printing ramps of varying density for each of the print die, and measuring the density with a densitometer.

6. The method for reducing die-to-die color inconsistencies in a multi-die printing system of claim 5, wherein the densitometer is integral with the printing system.

7. The method for reducing die-to-die color inconsistencies in a multi-die printing system of claim 1, wherein the linearization information comprises a look-up-table (LUT).

8. The method for reducing die-to-die color inconsistencies in a multi-die printing system of claim 1, wherein the linearization information comprises coefficients of a mathematical equation.

9. The method for reducing die-to-die color inconsistencies in a multi-die printing system of claim 1, wherein the printhead assembly includes printhead die for printing multiple ink colors, and wherein the method is repeated for each ink color.

10. The method for reducing die-to-die color inconsistencies in a multi-die printing system of claim 9, wherein the multiple ink colors comprise cyan, magenta, yellow, and black.

11. A method for reducing die-to-die color inconsistencies in a multi-die printing system, the printing system having at least one printhead assembly with multiple printhead die arranged sequentially along the at least one printhead assembly, with one die being an end die, the method comprising:
determining linearization information for the end die;
determining print densities for both the end die and a die sequentially adjacent to the end die; and
mapping the linearization information for the end die to the sequentially adjacent die utilizing the determined print densities.

12. The method for reducing die-to-die color inconsistencies in a multi-die printing system of claim 11, wherein the multiple printhead die comprise more than two printhead die, and wherein:
relative print densities are determined for each sequential pair of die;
and
the linearization information for the end die is mapped to each die by utilizing the determined relative print densities of every pair of die between the end die and said die.

13. The method for reducing die-to-die color inconsistencies in a multi-die printing system of claim 12, wherein determining relative print densities comprises printing ramps of varying density for each of the print die, and measuring the density with a densitometer.

14. The method for reducing die-to-die color inconsistencies in a multi-die printing system of claim 13, wherein the densitometer is integral with the printing system.

15. A computer readable media containing program instructions for reducing die-to-die color inconsistencies in a multi-die printing system, comprising:
program instructions for determining linearization information for one die;
program instructions determining relative print densities for the one die and at least one adjacent die; and
program instructions for mapping the linearization information for the one die to the at least one adjacent die based on the determined relative print densities.

16. The computer readable media containing program instructions of claim 15, wherein the program instructions for determining relative print densities comprises program instructions for printing ramps of varying density for each of the print die, and measuring the density with a densitometer.

17. The computer readable media containing program instructions of claim 15, wherein the linearization information comprises a look-up-table (LUT).

18. The computer readable media containing program instructions of claim 15, wherein the linearization information comprises coefficients of a mathematical equation.

19. The computer readable media containing program instructions of claim 15, wherein the program instructions include instructions for determining linearization information, determining relative print densities, and mapping the linearization information for multiple ink colors.

20. The computer readable media containing program instructions of claim 19, wherein the multiple ink colors comprise cyan, magenta, yellow, and black.
